(19) United States
(12) Patent Application Publication
(10) Pub. No.: US 2012/0023410 A1
(43) Pub. Date: Jan. 26, 2012

(54) COMPUTING DEVICE AND DISPLAYING METHOD AT THE COMPUTING DEVICE

(76) Inventors: Erik ROTH, Seoul (KR); Jinyung Park, Seoul (KR); Jaehwa Lee, Seoul (KR); Stanley Kim, Seoul (KR); Jiyeong Ku, Seoul (KR); Wookjin Chung, Seoul (KR); Soyoung Han, Seoul (KR); Heeyoung Hwang, Seoul (KR)

(21) Appl. No.: 12/897,148

(22) Filed: Oct. 4, 2010

Related U.S. Application Data
(60) Provisional application No. 61/365,790, filed on Jul. 20, 2010.

(51) Int. Cl. G06F 3/048

(52) U.S. Cl. 715/737; 715/748; 715/742

(57) ABSTRACT

The present invention provides a computing device that supports cloud service. The computing device of present invention includes a communication module configured to communicate with an external cloud database. The computing device also includes a display screen configured to display a cloud navigation area containing a cloud icon. The computing device also includes a processor configured to control to detect a user command of displaying cloud contents, the user command being detected by recognizing the cloud icon selected. The processor further configured to control the communication module to receive cloud contents from the external cloud database and to control the cloud navigation area to be enlarged within the display screen and the received cloud contents to be displayed within the enlarged cloud navigation area.

### CROSS REFERENCE TO RELATED APPLICATION

Pursuant to 35 U.S.C. §119(e), this application claims the benefit of earlier filing date and right of priority to U.S. Provisional Patent Application No. 61/365,790, filed on Jul. 20, 2010, the contents of which are hereby incorporated by reference herein in their entirety.

### TECHNICAL FIELD

The disclosed embodiments relate to a computing device and, more particularly, to a displaying method at the computing device.

### BACKGROUND ART

With the recent outstanding leap in the development of the IT technology, diverse IT-based products are being developed and produced. For example, a wide range of IT products from table-top products (or electronic devices), such as desktop personal computers (PC's), digital TV's, up to portable products (or electronic devices), such as smart phones, tablet PC's, and so on, are under research and development based upon their respective purpose. Also, the recently developed IT products tend to be of a new integrated form of high technology (or high tech) product type executing broadcasting functions, telecommunication functions, work station functions, and so on. Accordingly, since there is an immense difficulty in categorizing the wide variety of IT-based products solely based upon the characteristic names of the corresponding products, in the following description of the present invention, the wide range of such IT-based products will be collectively referred to as “computing devices” for simplicity. Accordingly, in the following description of the present invention, the term “computing device” will be broadly used to include existing IT products as well as a variety of new products that are to be developed in the future.

FIG. 1 illustrates a structure enabling a plurality of the above-described computing devices (11˜15) to perform wired or wireless communication with one another through a network. Recently, as a network-applied IT service, heated discussions have been made over network services referred to as “cloud computing” or a “cloud system.” Hereinafter, such network service will be referred to as a “cloud system” for simplicity. However, it should be known and understood that, instead of signifying a specific service method, and if the service corresponds to a contents sharing service using a network, the term “cloud service” mentioned in the description of the present invention will be used as a general and broad definition within the description of the present invention, without being limited to a particular service method.

The cloud service is capable of providing all types of IT-associated services. For example, referring to FIG. 1, a cloud server (21) configured to operate the cloud service, and a cloud database (22) configured to store diverse contents exist in a cloud service (20). The plurality of individual computing devices (11˜15) subscribed to the cloud service (20) or a user using such computing devices may be capable of using diverse contents (hereinafter referred to as “cloud contents”) stored in the cloud database (22). Herein, the cloud contents include not only contents (or documents) personally created and uploaded by a computing device user but also contents (or documents) created or provided by other shared users or internet service providers. Therefore, a computing device user may be capable of sharing and using the diverse cloud contents stored in the cloud database (22) through cloud services regardless of time and location.

### DISCLOSURE

### Technical Problem

However, since a detailed method of supporting cloud services within a computing device has not yet been proposed, the application of cloud services within the computing device remains limited. For example, in order to enable a user to efficiently and conveniently use cloud services, the computing device requires a graphical user interface (GUI) or user experience (UX) environment.

### Technical Solution

An object of the present application is to provide a computing device and a display method at the computing device for supporting a network service, such like the cloud service.

Additional advantages, objects, and features of the present application will be set forth in part in the description which follows and in part will become apparent to those having ordinary skill in the art upon examination of the following or may be learned from practice of the present application. The objectives and other advantages of the present application may be realized and attained by the structure particularly pointed out in the written description and claims hereof as well as the appended drawings.

To achieve these objects and other advantages and in accordance with the purpose of the invention, as embodied and broadly described herein, a computing device includes a communication module, a display screen, and a processor. Herein, the communication module is configured to communicate with an external cloud database. The display screen is configured to display a cloud navigation area containing a cloud icon. The processor is configured to control to detect a user command of displaying cloud contents. Herein, the user command may be detected by recognizing the cloud icon selected, the processor may be configured to control the communication module to receive cloud contents from the external cloud database, and the processor may be further configured to control the cloud navigation area to be enlarged within the display screen and the received cloud contents to be displayed within the enlarged cloud navigation area.

In another aspect of the present invention, a displaying method at a computing device having a display screen configured to display a cloud navigation area containing a cloud icon, includes detecting a user command for displaying cloud contents, the user command being detected by recognizing the cloud icon selected, communicating with an external cloud database and receiving cloud contents from the external cloud database, and enlarging the cloud navigation area within display screen for displaying the received cloud contents.

In another aspect of the present invention, a computing device includes a communication module, a display screen, and a processor. Herein, the communication module is configured to receive cloud contents from an external cloud database during a normal state. The display screen is configured to display images, wherein the display screen displays a cloud navigation area containing a cloud icon and at least one recent saved file among the received cloud contents. And, the processor is configured to control to detect a user command of displaying the received cloud contents. Herein, the user command is by recognizing the cloud icon selected, and the processor is further configured to control the cloud navigation area to be enlarged within the display screen and the received cloud contents to be displayed within the enlarged cloud navigation area according to the user command.

In another aspect of the present invention, a computing device includes a display screen, a processor, and a memory. The display screen displays a cloud navigation area containing a cloud icon. The memory is configured to store one or more programs, wherein the one or more programs to be executed by the processor, the one or more programs including instructions for: detecting a user command for displaying cloud contents, the user command being detected by recognizing the cloud icon selected; communicating with an external cloud database and receiving cloud contents from the external cloud database; and enlarging the cloud navigation area within display screen for displaying the received cloud contents.

In another aspect of the present invention, a file storing method at a computing device having a display screen configured to display a main display area and a cloud navigation area, includes detecting a user command for moving a file from the computing device to an external cloud database, the user command being detected by recognizing user's file drag gesture from the main display area to the cloud navigation area, determining whether the file will be remained in the computing device after moving process is performed, and transmitting the file dragged to the cloud navigation area to the external cloud database, with or without remaining the file in the computing device based on a result of the determining step.

In a further aspect of the present invention, a file storing method at a computing device having a display screen configured to display a main display area and a cloud navigation area, includes detecting a user command for moving a file from an external cloud database to the computing device, the user command being detected by recognizing user's file drag gesture from the cloud navigation area to the main display area, determining whether the file will be remained in the external cloud database after moving process is performed, and storing the file dragged to the display screen in the computing device with or without remaining the file in the external cloud database based on a result of the determining step.

### Advantageous Effect

By realizing the embodiment of the present invention, the user may be capable of efficiently using cloud services by using his (or her) own (or personal) computing device.

### DESCRIPTION OF DRAWINGS

FIG. 1 illustrates a general cloud service environment applied in the present invention.

FIG. 2 illustrates a block view showing the structure of a computing device according to an embodiment of the present invention.

FIG. 3 illustrates outside features of a computing device including a display screen according to the embodiment of the present invention.

FIG. 4 illustrates an exemplary usage in a cloud navigation area according to the embodiment of the present invention.

FIG. 5 illustrates another exemplary usage in the cloud navigation area according to the embodiment of the present invention.

FIG. 6 illustrates an exemplary expanded screen of the cloud navigation area according to the embodiment of the present invention.

FIG. 7 illustrates an exemplary usage in an expanded cloud navigation area according to the embodiment of the present invention.

FIG. 8 illustrates another exemplary usage in the expanded cloud navigation area according to the embodiment of the present invention.

FIG. 9 and FIG. 10 illustrate yet another exemplary usage in the expanded cloud navigation area according to the embodiment of the present invention.

FIGS. 11˜13 illustrate a file storing method using the cloud navigation method according to another embodiment of the present invention.

### BEST MODE

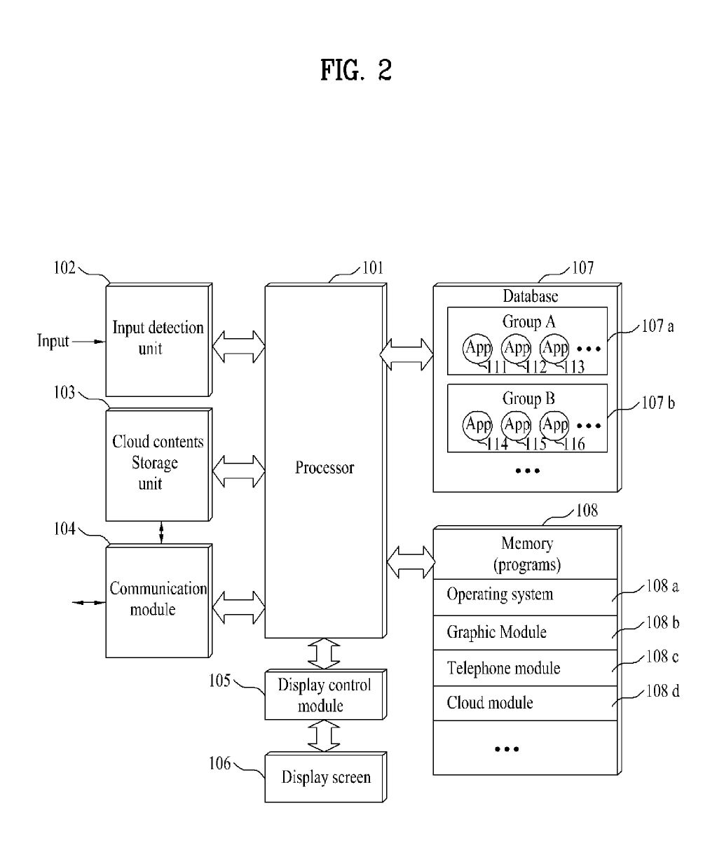

FIG. 2 illustrates an inner structure of a computing device (100) supporting a cloud service according to an embodiment of the present invention. As described above, the term “computing device” used in the description of the present invention is broadly used to include existing IT products as well as a variety of new products that are to be developed in the future.

The computing device (100) according to the present invention includes a processor (101), an input detection unit (102), a cloud contents storage unit (103), a communication module (104), a display control module (105), a display screen (106), a database (107), and a program memory (108). In addition to the above-described structure, although it is not shown in FIG. 2, it is apparent that a variety of other components (or elements), such as a power supply, an audio speaker, a micro phone, and so on, may be included in the computing device (100).

The input detection unit (102) translates (or analyzes) user commands inputted from an external source and, then, delivers the translated user command to the processor (101). For example, when a specific button provided on the display screen (106) is pressed or clicked, information that the corresponding button has been executed (or activated) (i.e., pressed or clicked) is sent to the processor (101). Also, for example, in case the display screen (106) includes a touch screen module capable of recognizing (or detecting or sensing) a user's touch (i.e., touch-sensitive), when the user performs a touch gesture on the touch screen, the input detection unit (102) analyzes the significance of the corresponding touch gesture, thereby performing a final conversion of the corresponding touch gesture to a user command, thereby sending the converted user command to the processor (101).

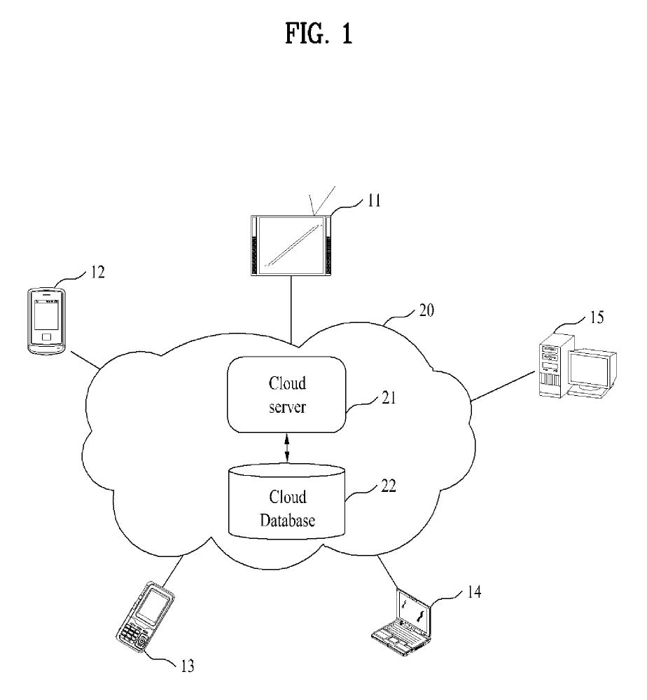

The database (107) is configured to store diverse applications (111, 112, 113, 114, 115, and 116) operating in the computing device (100). For example, the applications include both applications automatically set-up by the system and applications arbitrarily or (randomly) set-up by the user. Furthermore, the diverse applications may be integrated as a group (107a and 107b) so as to be managed. And, the application group (107a and 107b) may, for example, be automatically grouped by the processor (101) or be randomly (or arbitrarily) grouped and set-up by the user. However, in the computing device supporting a cloud service according to the embodiment of the present invention, rather than storing a large number of applications occupying a considerable amount of storage capacity, the computing device stores the applications in the cloud database (e.g., reference numeral 22 of FIG. 1) within the corresponding cloud service, so as to be used.

The program memory (108) includes diverse driving programs driving the computing device (100). For example, the program memory 108 may include an operating system program (108a), a graphic module program (108b), a telephone module program (108c), and a cloud module program (108d). However, it is apparent that in addition to the above-mentioned programs, other programs may also be included. Most particularly, a cloud module program (108d) for supporting cloud services is stored in the program memory (108), and the usage of diverse cloud services that are to be described later on are realized by having the processor (101) execute the contents programmed by the cloud module program (108d).

Also, the display screen (106) performs the function of providing a visual screen to the user, which may be realized by using a variety of methods, such as LCD, LED, OLED, and so on. Moreover, the display screen (106) may further include a touch-sensitive display module (referred to as a “touch screen” for simplicity), which can sense or detect a touching motion (or gesture) of the user. In case of the recently developed portable computing devices (e.g., smart phones, tablet PCs, electronic photo frames, and so on), the adoption of the touch screen is becoming more common for the convenience of the users. An example of applying the above-described touch screen is given in the embodiment, which will be described in detail in the following description of the present invention. However, this is merely exemplary and the technical scope and spirit of the present invention will not be limited only to the application of touch screens. Furthermore, the display control module (105) physically and/or logically controls the display operations of the display screen (106).

Additionally, the communication module (104) performs the communication between the computing device (100) and an external device or a network. Herein, in case of the computing device (100) according to the present invention, which supports cloud services, the communication module (104) particularly performs the communication with between the computing device and an external server (e.g., reference numeral 21 of FIG. 1) or a cloud database (e.g., reference numeral 22 of FIG. 1), so as to transmit and receive information and contents to and from one another. Various communication methods including wired and wireless communication already exist, and since the details of such communication methods are not directly associated with the present invention, detailed description of the same will be omitted for simplicity.

Also, the cloud contents storage unit (103) temporarily stores the cloud contents that are received through the communication module (104) on the computing device (100). For example, the cloud contents correspond to contents stored inside the above-described cloud database (e.g., reference numeral 22 of FIG. 1), the cloud contents including diverse types of contents including movies, photos, music (or songs), documents, programs, and so on. Furthermore, the contents stored in the cloud database (e.g., reference numeral 22 of FIG. 1) may be categorized into individual-user-specific contents for specific users only and shared-usage-specific contents shared by multiple users. For example, a user using the computing device (100) stores his (or her) own personal contents within the cloud database. Accordingly, the user may be able to access and use the cloud server regardless of the time and place (or location), so as to verify his (or her) own personal contents stored within the cloud database and to use the corresponding contents. Also, depending upon the type of the cloud service, the shared-usage-specific contents may be shared to each user. Therefore, the cloud contents storage unit (103) may be used as a storage space for temporarily downloading and using the cloud contents. Herein, the cloud contents storage unit (103) may be used by being assigned with a predetermined memory region within a data memory (not shown), which exists in the computing device (100). However, the present invention will not be limited to the examples presented herein.

Furthermore, by driving the programs included in the above-described program memory (108), the processor (101) controls the operation of each element (or component) included in the computing device (100).

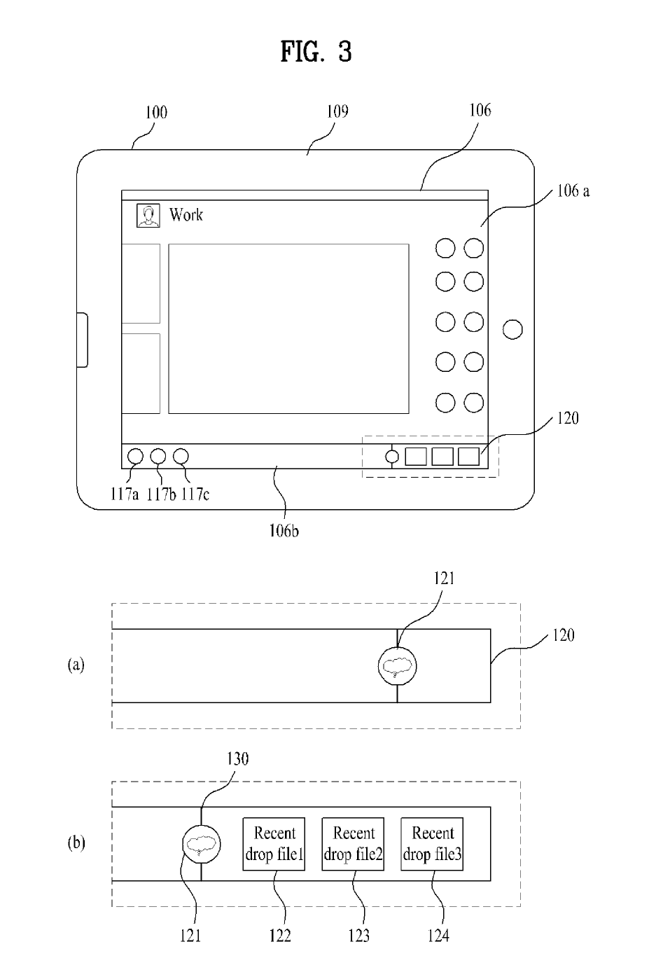

FIG. 3 illustrates outside features of a computing device (100) including a display screen according to the embodiment of the present invention. Herein, the computing device (100) may be configured to include a display screen (106) and a frame (109) surrounding the outer surface of the computing device (100) including the display screen (106). However, a structure having only the display screen (106) without the frame (109) may also be provided.

The display screen (106) includes a main display area (106a) configured to display an application that is currently being executed by the user, and a global application area (106b) configured to display a shared (or common) application that is globally used on a daily basis. In the description of the present invention, a state graded as a normal state will be referred to as a “normal state” for simplicity. The global application area (106b) may generally be configured to have a bar type shape of a long rectangular form. However, the present invention will not be limited to the example proposed herein. Most particularly, the applications that are displayed in the global application area (106b) may be configured of applications that are frequently used for common (or shared) usage, such as a phone application (117a), a mail application (117b), a messenger application (117c), and so on.

According to the embodiment of the present invention, in a normal state, a cloud navigation area (120) is further included in the global application area (106b). The cloud navigation area (120) may include an application that supports cloud services. The cloud navigation area (120) includes a cloud icon (121) for at least providing cloud services to the user. Hereinafter, the configuration of the cloud navigation area (120) in a normal state will be described in detail with reference to FIGS. 3 (a) and (b).

FIG. 3 (a) illustrates an exemplary configuration of the cloud navigation area (120) in a normal state. This example shows a case wherein, in a normal state, the cloud navigation area (120) includes only a cloud icon (121). Also, FIG. 3 (b) illustrates another exemplary configuration of the cloud navigation area (120) in a normal state. This example shows a case wherein, in a normal state, the cloud navigation area (120) includes at least one or more recent files (122, 123, and 124) among the cloud contents.

First of all, in the example of FIG. 3(a), in a normal state, the computing device (100) does not drive (or operate) a cloud service without the user's directions (or commands). More specifically, when the user executes the cloud icon (122) by touching or clicking on the cloud icon (122) within the cloud navigation area (120), the cloud service may be initiated.

Conversely, in the example of FIG. 3(b), in a normal state, the computing device (100) drives (or operates) a cloud service in advance even without the user's directions (or commands). More specifically, when power of the computing device (100) is turned on (i.e., power on), the processor (101) begins communication with a cloud server (e.g., reference numeral 21 of FIG. 1), which is located outside. And, accordingly, cloud contents associated with the user are received from the cloud database (e.g., reference numeral 22 of FIG. 1). Thereafter, the received cloud contents are temporarily stored in the above-described cloud contents storage unit (103). Then, among the received cloud contents, at least one or more of the recently updated files or the recently stored files are displayed within the cloud navigation area (120). For example, FIG. 3(b) shows an example of displaying 3 of the recent files (122, 123, and 124) by the order of the most recently updated or stored, in a normal state. In the following description of the present invention, the state of FIG. 3(b) will be referred to as a “cloud ready state”, and, in contrast, the state of FIG. 3(a) will be referred to as a “non-cloud ready state”, for simplicity.

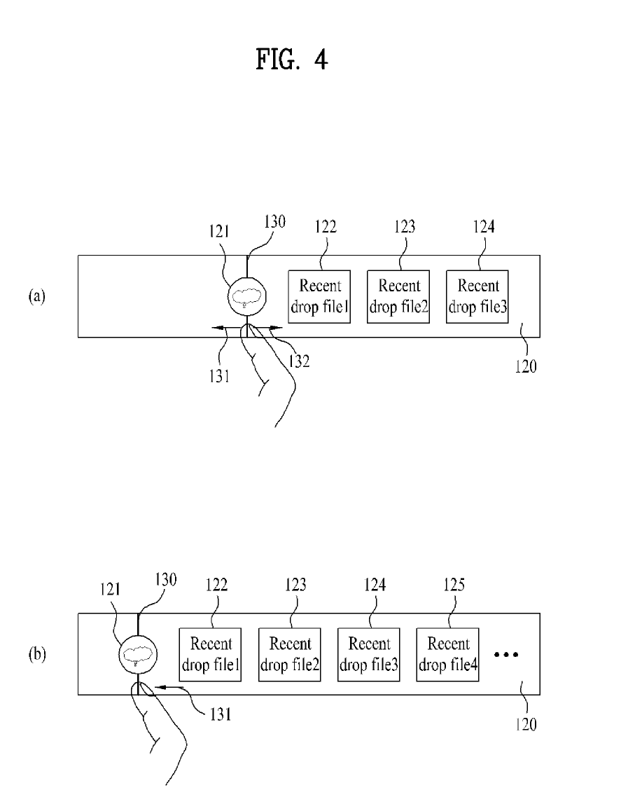

Furthermore, in FIG. 3(b), the reference numeral 130 signifies a control bar, and the usage of the control bar will be described in detail with reference to FIG. 4. FIG. 4(a) illustrates an example where, in the normal state, as shown in FIG. 3(b), the user touches the control bar (130) and performs a dragging motion (or gesture) to a wanted horizontal direction, i.e., either to the left (131) or to the right (132). More specifically, as shown in the example of FIG. 4(b), when the control bar (130) is dragged to the left (131), the recent files of the next order (i.e., the 4^{th} recent file, reference numeral 125) are further displayed within the cloud navigation area (120). Alternatively, when the control bar (130) is dragged to the right (132), the 3^{rd} file disappears from the cloud navigation area (120).

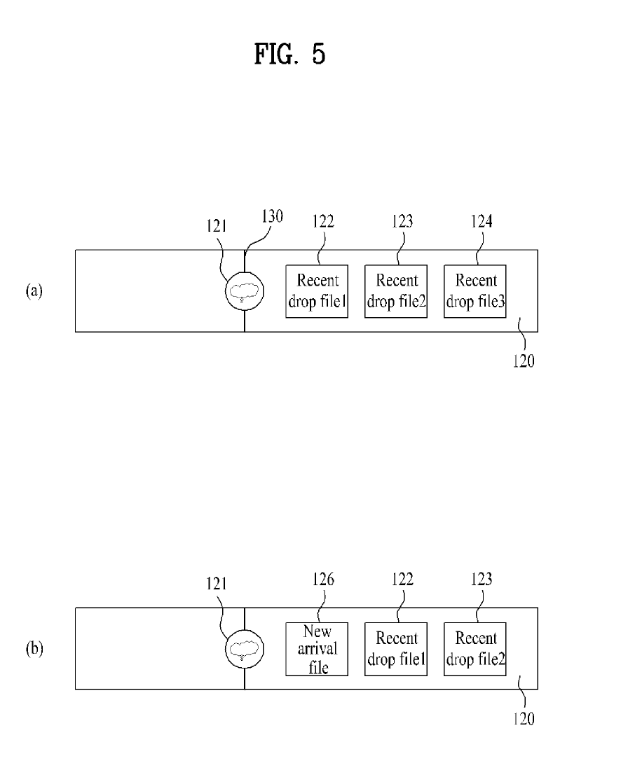

FIG. 5 illustrates another exemplary usage in the cloud navigation area (120) according to the embodiment of the present invention. FIG. 5(a) corresponds to a display state of the cloud navigation area (120) in the same normal state as the one shown in FIG. 3(b). In the normal state of FIG. 5(a), even during the time when the user is not aware, the processor (101) continuously receives cloud contents associated with the user from an external cloud database (e.g., reference numeral 22 of FIG. 1) through the communication module (104). FIG. 5(b) illustrates an example wherein new cloud contents (126) are received, in the normal state. More specifically, when the most recent new cloud contents (126) are received, the received contents (126) are displayed in the position of the most recent file (e.g., immediately next to the cloud icon (121)) within the cloud navigation area (120). At this point, in order to attract the user's attention, the cloud icon (121) may change its color, or the cloud icon (121) may be shifted to a blinking state.

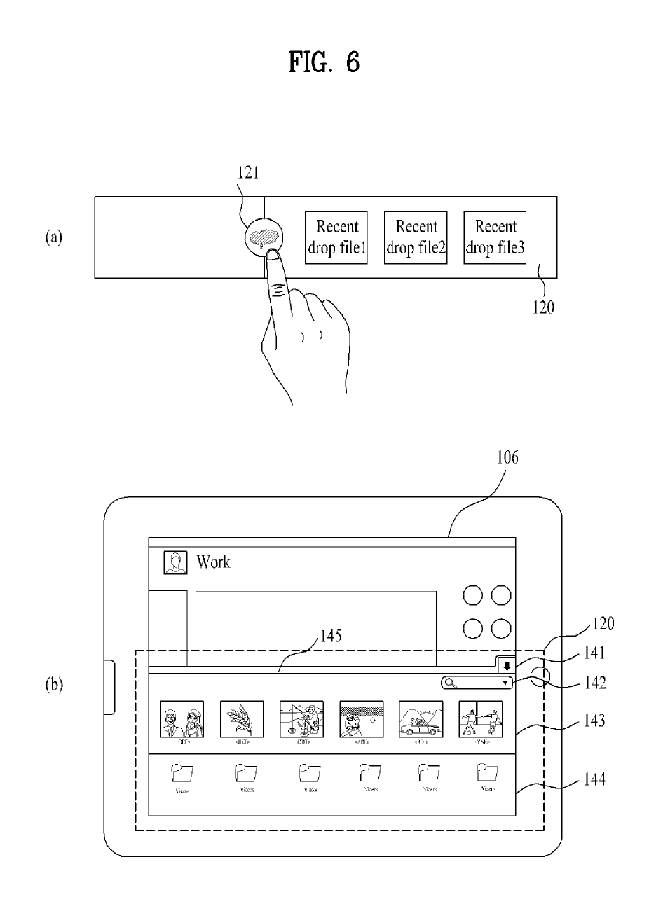

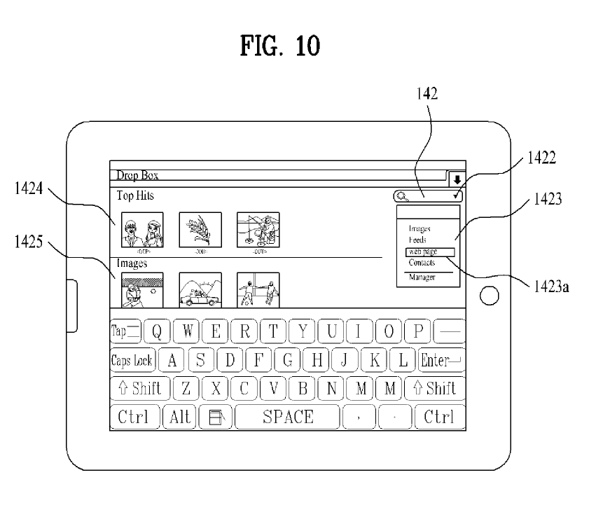

FIG. 6˜FIG. 10 illustrate examples of realizing the cloud services by executing the cloud icon (120).

First of all, FIG. 6(a) and FIG. 6(b) illustrate a first process of executing the cloud con (121). Herein, FIG. 6(a) illustrates the same normal state as the one shown in FIG. 3(b). Nevertheless, it is apparent that the same operations may be applied in the normal state wherein only the cloud icon (121) exists, as shown in FIG. 3(a).

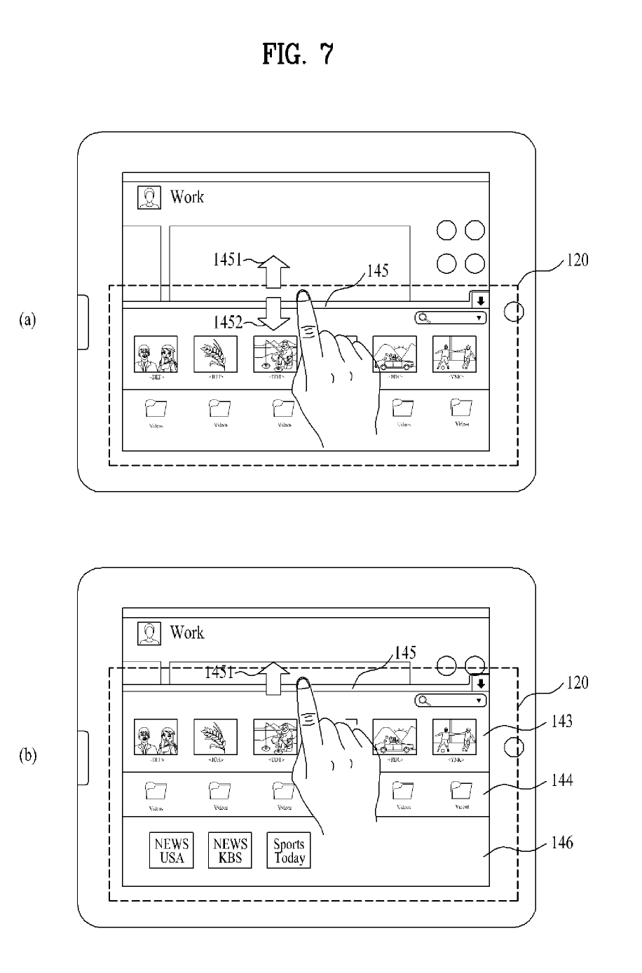

When the user touches the cloud icon (121) within the cloud navigation area (120), so as to execute the cloud icon (121), as shown in FIG. 6(a), the cloud navigation area (120) is expanded (or enlarged), as shown in FIG. 6(b), and displayed on the display screen (106). In order to distinguish this state from the above-described normal state, this state will be referred to as an “enlarged state”. In the enlarged state, the cloud contents that are stored in the cloud contents storage unit (103) are displayed in more detail. In the enlarged state, a field that is being displayed within the cloud navigation area (120) may include, for example, a close icon field (141), a search function field (142), a cloud contents display field (143 and 144), and a control bar (145). Most particularly, the cloud contents display field (143 and 144) may be displayed by contents groups, which are categorized based on the characteristics of the cloud contents. For example, FIG. 6(b) shows an example of the cloud contents being categorized as a recently received contents group (143) and a contents group (144) stored by the user (or user-stored contents group), thereby being displayed. Hereinafter, the operations of each field will be described in detail with reference to FIG. 7˜FIG. 10.

FIG. 7 describes a change in the cloud contents display field (143, 144, and 146) based upon the movement of the control bar (145). For example, as shown in FIG. 7(a), after touching the control bar (145), the user may drag the control bar (145) to a wanted vertical direction, i.e., either up (or upward direction) (1451) or down (or downward direction) (1452).

For example, FIG. 7(b) shows an example of the control bar (145) being dragged by the user to an upward direction (1451). When the control bar (145) is dragged to an upward direction (1451), the overall cloud navigation area (120) is further enlarged. Therefore, in the enlarged region, portions of the cloud contents display field (146) that were not displayed in the previous enlarged state are further displayed. The newly displayed cloud contents display field (146) also corresponds to the specific group that is categorized based on the characteristics of the cloud contents. For example, FIG. 7(b) illustrates a contents group (146) that is fed to the user from the cloud server, as shared-usage-specific contents.

Herein, it is preferable that the order of display of the groups, which are categorized based on the characteristics of the cloud contents, in the enlarged state is pre-decided. For example, the order of display may be decided in connection with the current main application that is being executed by the user. For example, when the user executes the “work” application, as described above, the order of display may be decided as the most recently received contents group (143), the user-stored contents group (144), and the fed contents group (146) within the cloud navigation area (120) starting from the upper portion of the cloud navigation area (120) and downwards. Also, when the user executes the “play” application, the order of display is changed to the fed contents group (146), the most recently received contents group (143), and the user-stored contents group (144) within the cloud navigation area (120) starting from the upper portion of the cloud navigation area (120) and downwards. Accordingly, the above-described processor (101) may be capable of displaying cloud contents groups by the pre-decided order of display, in accordance with the type of application that is being executed with the main display area (106a).

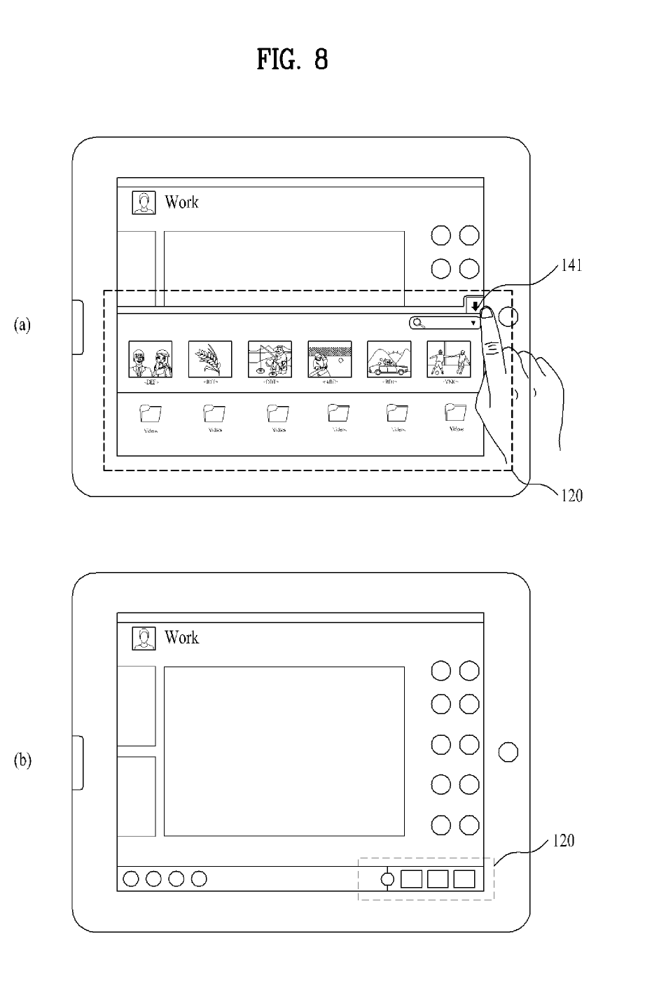

FIG. 8 describes an exemplary usage of a close icon field (141). As shown in FIG. 8(a), in an enlarged state, the close icon field (141) is displayed near the upper portion of the cloud navigation area (120). If the user touches or clicks the close icon field (141), the enlarged state is ended, and the displayed screen returns to the normal state. FIG. 8(b) illustrates the computing device (100) that is returned to the normal state. Herein, it is shown that the cloud navigation area (120) maintains a normal state.

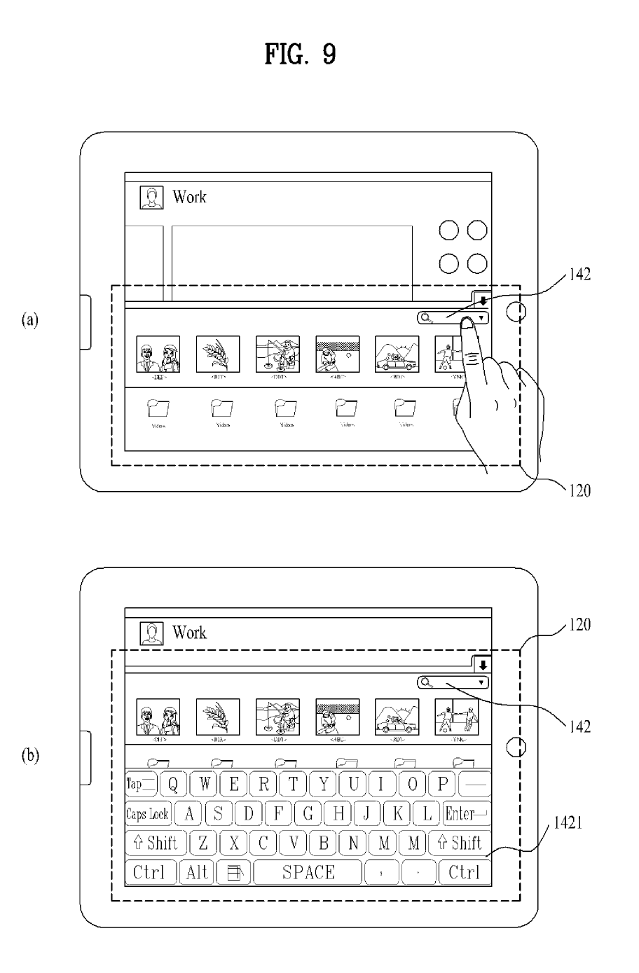

FIG. 9 and FIG. 10 describe an exemplary usage of a search function field (142). The search function field (142) helps the user to perform a wanted search on the shared contents within the cloud database (reference numeral 22 of FIG. 1).

As shown in FIG. 9(a), the search function field (142) is displayed near the upper portion of the cloud navigation area (120). If the user touches or clicks the search function field (142), as shown in FIG. 9(b), a touch keyboard (1421) is displayed on the lower portion of the cloud navigation area (120). Thereafter, the user uses the touch keyboard (1421) to input a wanted search word. Then, when the user touches or clicks on a control button (1422) positioned on the search function field (142), a search window (1423) that can designate a search area (or region) is displayed, as shown in FIG. 10. When the user selects one of a plurality of search areas on the search window (1423), and when the user touches or clicks on the selected search area (e.g., Search “Web pages”), a wanted searched result (1424 and 1425) is displayed on the contents display field within the cloud navigation area (120). Furthermore, the searched result may also be displayed by groups categorized based on the characteristics of the searched results.

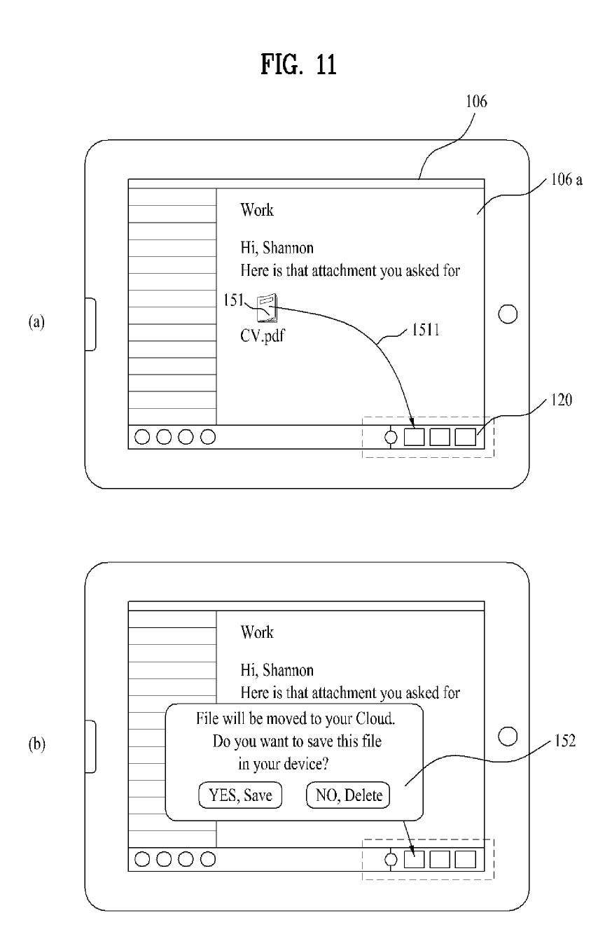

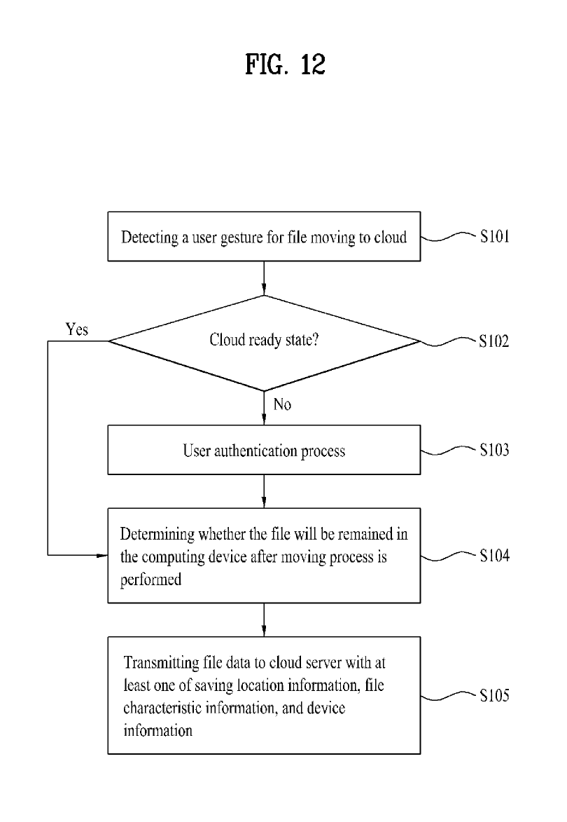

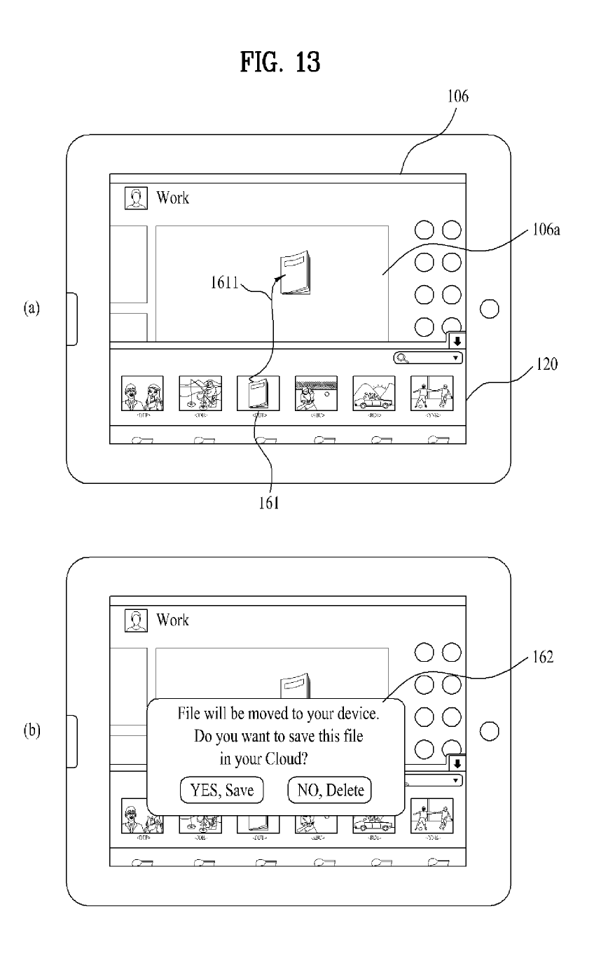

FIG. 11˜FIG. 13 illustrate a file storing method using the cloud navigation method according to another embodiment of the present invention.

FIG. 11(a) illustrates an exemplary display of a main display area (106a) and a cloud navigation area (120) of an application, which is currently being displayed by the user within the above-described display screen (106), in a normal state. Most particularly, FIG. 11(a) corresponds to a case where the user wishes to move (or reposition) a specific file (151) located in the main display area (106a) to an external cloud database (e.g., reference numeral 22 of FIG. 1) to which the user is registered and/or subscribed. Herein, the specific file (151) corresponds to a file that is stored within the computing device (100). For example, the specific file (151) may correspond to an attachment file that has been received through a mailing function. As the user repositions and stores the specific file (151) in the cloud database, the user may be capable of easily and conveniently verifying the specific file (151) at any time and at any place by using the cloud service.

In order to reposition the specific file (151) of the main display area (106a) to the cloud database, the user should touch the specific file (151) within the main display area (106a) and then drag (1511) the specific file (151) into the cloud navigation area (120). The above-described input detection unit (102) of FIG. 2 detects (or recognizes or senses) the user's gesture (or motion), which is then delivered to the processor (101). Thereafter, the processor (101) drives a cloud module program (108d) within the program memory (108) so as to control the computing device (100) to store the specific file (151) within the cloud database.

Herein, prior to executing the user command to store the specific file (151) in the cloud database, a process of deciding whether or not to maintain storage of the corresponding file (151) within the computing device (100) is required to be performed. FIG. 11(b) shows an example of a guide window (152) asking (or inquiring) whether or not the user wishes to maintain storage of the corresponding file (151) within the computing device (100). Then, in accordance with the selection of the user, the specific file (151) shall be stored in the cloud database and, at the same time, either kept in the computing device (100) for further storage or deleted.

FIG. 12 illustrates a detailed flow chart showing the process steps of a file storing process within the cloud database according to the present invention. First of all, the input detection unit (102) of the computing device (100) verifies a user gesture, such as the above-described file dragging gesture, which seeks to reposition (or move) a specific file to the cloud database (S101). Then, the processor (101) verifies whether the current normal state of the display screen corresponds to a cloud ready state of FIG. 3(b) or to a non-cloud ready state of FIG. 3(a) (S102).

For example, based upon the verified result of step S102, if the current state corresponds to the non-cloud ready state of FIG. 3(a), the processor (101) performs a user authentication process (S103). More specifically, since the non-cloud ready state corresponds to a state prior to being connected to the respective cloud service, in case the user attempts to access the cloud database via file repositioning, the processor (101) is required to verify and authenticate the corresponding user as a user formally and truly subscribed to the corresponding cloud service. For example, step 103 may be performed in accordance with a log-in method, which is one of the most generally and broadly used methods. And, in this case, the user authentication process may be substituted with a simple process of inputting a user ID and a password.

Also, for example, based upon the verified result of step S102, if the current state corresponds to the cloud ready state of FIG. 3(b), the file may be immediately repositioned (or moved) without having to go through any separate user authentication process. As described above, the cloud ready state corresponds to a state wherein the respective cloud service is already open. Therefore, it is generally known that user authentication has already been completed with the access to the cloud server (reference numeral 21 of FIG. 1). Nevertheless, the computing device (100) may be designed so that, even though the display screen is in the cloud ready state, if the user authentication process has not yet been performed, the user gesture of step 101 can be recognized as a log-in gesture (or command) to the respective cloud service, thereby enabling the user to be connected to the cloud server without any separate user authentication process.

As shown in FIG. 12, step S104 corresponds to a process step of verifying with the user whether the user wishes to maintain storage of the file, which is to be moved to the cloud database, in the computing device (100).

Thereafter, step S105 corresponds to a process step for transmitting the data and information associated with the storage of a specific file into the cloud database to the cloud server. Herein, in step S105, in addition to the actual file data, supplemental information associated with the file storage and authentication may also be transmitted.

For example, among the diverse supplemental information, saving location information may be transmitted. Herein, this information corresponds to information that can designate the storage (or saving) location of the transmitted file within the cloud database. For example, when storing the corresponding file in the cloud database, the user may be able to predetermine the saving location of the corresponding file. More specifically, the saving location may be varied for each type of computing devices (100). In other words, depending upon whether the computing device (100) transmitting the corresponding file is a tablet PC, a smart phone, or another type of device, the saving location of the transmitted file within the cloud database may be differently set-up. Herein, the saving location information corresponds to information used to provide such differentiation (or classification) to the cloud server.

As another example, among the diverse supplemental information, file characteristic information may be transmitted. Herein, this information corresponds to information that can indicate the characteristics of the file that is being transmitted. For example, this information indicates whether the file being transmitted corresponds to a moving picture file, an photo image file, a music file, or a file of a completely different characteristic. The cloud server may also decide the saving location of the transmitted file by using this information.

As yet another example, among the diverse supplemental information, device information may be transmitted. This information may contain data corresponding to the type of the computing device (100) that is currently being used and also to a GPS location of the corresponding computing device (100). Additionally, diverse information indicating the characteristics of the device may also be included. And, such device information may be used by the cloud server for performing the authentication process of the corresponding device or for deciding the saving (or storage) location of the file that is being transmitted.

The supplemental information, such as saving location information, file characteristic information, and device information, may be transmitted along with the actual file data through step S105, or at least one or more of the supplemental information may be selectively transmitted.

FIG. 13(a) illustrates an exemplary display of the main display area (106a) and the enlarged cloud navigation area (120), wherein an application that is currently being executed by the user, in an enlarged state. Particularly, in the enlarged station, FIG. 13(a) corresponds to an example wherein the user wishes to reposition a specific file (161) displayed in the cloud navigation area (120) into the computing device (100). Herein, the specific file may be a file corresponding to user-specific contents stored in the cloud database (reference numeral 22 of FIG. 1), or the specific file may be a file corresponding to shared contents authorized for free usage. The user may be able to reposition and store (or save) the specific file (161) within the computing device (100), which is currently being used, from the cloud database (reference numeral 22 of FIG. 1) whenever the user wishes.

In order to reposition the file (161) stored in the cloud database (reference numeral 22 of FIG. 1), the user should touch the specific file (161) within the expanded cloud navigation area (120) and then drag (1611) the specific file (161) into the main display area (106a). The above-described input detection unit (102) of FIG. 2 detects (or recognizes or senses) the user's gesture (or motion), which is then delivered to the processor (101). Thereafter, the processor (101) drives (or operates) a cloud module program (108d) within the program memory (108) so as to control the file (161) stored in the cloud database or the file (161) temporarily stored in the cloud contents storage unit (103) to be stored in a storage means (not shown) within the computing device (100).

Herein, prior to executing the user command to store the specific file (161) in the cloud database, a process of deciding whether or not to maintain storage of the corresponding file (161) within the cloud database (reference numeral 22 of FIG. 1) is required to be performed. FIG. 13(b) shows an example of a guide window (162) asking (or inquiring) whether or not the user wishes to maintain storage of the corresponding file (161) within the cloud database. Then, in accordance with the selection of the user, the specific file (161) shall be stored in the computing device (100) and, at the same time, either kept in the cloud database for further storage or deleted.

### INDUSTRIAL APPLICABILITY

The embodiment of the present invention is associated to a cloud service software program within the computing device (100) for enlarging a cloud service or cloud system. Furthermore, various embodiments of the present invention proposed in the description of the present invention may be used so that the user can easily realize a cloud service by using his (or her) own computing device.

1. A computing device, comprising:
a communication module configured to communicate with an external cloud database;
a display screen configured to display a cloud navigation area containing a cloud icon; and
a processor configured to control to detect a user command of displaying cloud contents, the user command being detected by recognizing the cloud icon selected, the processor configured to control the communication module to receive cloud contents from the external cloud database, and the processor further configured to control the cloud navigation area to be enlarged within the display screen and the received cloud contents to be displayed within the enlarged cloud navigation area.

2. The computing device of claim 1, wherein the processor is configured to further control the received cloud contents to be categorized by based on a characteristic of the cloud contents and control the categorized cloud contents to be displayed within the enlarged cloud navigation area.

3. The computing device of claim 1, wherein the computing device further comprises:
a storage configured to temporarily store the received cloud contents from the external cloud database.

4. The computing device of claim 2, wherein the computing device further comprises:
a storage configured to temporarily store the categorized cloud contents.

5. A displaying method at a computing device having a display screen configured to display a cloud navigation area containing a cloud icon, comprising:
detecting a user command for displaying cloud contents, the user command being detected by recognizing the cloud icon selected;
communicating with an external cloud database and receiving cloud contents from the external cloud database; and
enlarging the cloud navigation area within display screen for displaying the received cloud contents.

6. The method of claim 5, the method further comprising:
categorizing the received cloud contents based on a characteristic of the cloud contents.

7. The method of claim 5, the method further comprising:
temporarily storing the received cloud contents in a storage.

8. The method of claim 6, the method further comprising:
temporarily storing the categorized cloud contents in a storage.

9. The computing device of claim 1, wherein the communication module is configured to receive cloud contents from the external cloud database during a normal state; and
the display screen is configured to display images during the normal state, wherein the display screen displays the cloud navigation area containing the cloud icon and at least one recent saved file among the received cloud contents.

10. The computing device of claim 1, wherein the computing device further comprising:
a memory configured to store one or more programs, wherein the one or more programs are to be executed by the processor, the one or more programs including instructions for:
detecting the user command for displaying cloud contents, the user command being detected by recognizing the cloud icon selected;
communicating with the external cloud database and receiving cloud contents from the external cloud database; and
enlarging the cloud navigation area within display screen for displaying the received cloud contents.

11. A file storing method at a computing device having a display screen configured to display a main display area and a cloud navigation area, comprising:
detecting a user command for moving a file from the computing device to an external cloud database, the user command being detected by recognizing user's file drag gesture from the main display area to the cloud navigation area;
determining whether the file will be remained in the computing device after moving process is performed; and
transmitting the file dragged to the cloud navigation area to the external cloud database, with or without remaining the file in the computing device based on a result of the determining step.

12. The method of claim 11, the method further comprising:
transmitting additional information to identify a saving location of the file in the cloud database.

13. The method of claim 11, the method further comprising:
transmitting additional information to identify a characteristic of the file.

14. The method of claim 11, the method further comprising:
transmitting additional information to identify a characteristic of the computing device.

15. The method of claim 11, the method further comprising:
performing user authentication process if the computing device is under non-cloud-ready state.

16. The method of claim 11, wherein
if the computing device is under a cloud-ready state, user authentication process is omitted.

17. (canceled)
